(19) United States
(12) Patent Application Publication
(10) Pub. No.: US 2008/0052473 A1
(43) Pub. Date: Feb. 28, 2008

(54) INFORMATION PROCESSING APPARATUS

(76) Inventors: Nobuo Yagi, Machida (JP); Kazunari Tanaka, Hadano (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/829,123

(22) Filed: Jul. 27, 2007

(30) Foreign Application Priority Data
Jul. 28, 2006 (JP) 2006-205554

(51) Int. Cl. G06F 12/02

(52) U.S. Cl. 711/150; 711/E12.002

(57) ABSTRACT

A system controller which controls a plurality of storage devices comprises a unit which divides data of processor bus width from a processor into a plurality of divided data, a first transfer unit which simultaneously transfers the divided plurality of divided data to the plurality of storage devices distributing them, a second transfer unit which time divides the divided plurality of divided data and sequentially transfers them to the same storage device, and a mode control unit which operates either the first transfer unit or the second transfer unit.

### BACKGROUND OF THE INVENTION

The present invention relates to an information processing apparatus which can flexibly realize a high performance system, a high reliability system which realizes a redundant memory configuration and memory hot-swap, and a low cost system which has a small storage capacity using a single apparatus.

Conventionally, the interleave, the redundant memory configuration, and the memory hot-swap were performed with the data width in transfer units of a bus between processor and north bridge (the processor bus width). As in order to perform the interleave, the redundant memory configuration, and the memory hot-swap with the processor bus width the bus between north bridge and storage device needs to have equal to or more than twice of throughput to the throughput of the bus between processor and north bridge, it was difficult to realize the redundant memory configuration and the memory hot-swap in a small scale information processing apparatus.

### SUMMARY OF THE INVENTION

It is an object of the present invention to flexibly realize a high performance system, a high reliability system, and a low cost system according to a request of a system in a small scale information processing apparatus comprising the bus between north bridge and storage device which has the throughput as same as the bus between processor and north bridge.

The present invention is an information processing apparatus comprising a processor, a plurality of storage devices, and a system controller which controls the plurality of storage devices, wherein the system controller comprises a unit which divides data of processor bus width from the processor into a plurality of divided data, a first transfer unit which simultaneously transfers the divided plurality of divided data to the plurality of storage devices distributing them, a second transfer unit which time divides the divided plurality of divided data and sequentially transfers them to the same storage device, and a mode control unit which operates either the first transfer unit or the second transfer unit.

Further, the present invention is an information processing apparatus wherein the system controller comprises a third transfer unit which combines the plurality of divided data read out simultaneously at a time from the plurality of storage devices into data of processor bus width and transfers it to the processor, and a fourth transfer unit which combines the plurality of divided data sequentially read out in a plurality of times separately from one storage device into data of processor bus width and transfers it to the processor, and the mode control unit operates the third transfer unit when it operates the first transfer unit and operates the fourth transfer unit when it operates the second transfer unit.

According to the present invention it is possible to flexibly realize a high performance system, a high reliability system, and a low cost system according to the request from the system (the user) even in a small scale information processing apparatus.

### BRIEF DESCRIPTION OF THE DRAWINGS

FIG. 1 is a configuration diagram of a processor, a north bridge, and a storage device in an information processing apparatus.

FIG. 2 is a configuration diagram of a write engine in the north bridge.

FIG. 3 is a configuration diagram of a read engine in the north bridge.

FIG. 4 is an operation chart of a mode controller in a high reliability mode and in a low cost mode.

FIG. 5 is a write operation timing chart in a high performance mode.

FIG. 6 is a write operation timing chart in the high reliability mode and in the low cost mode.

FIG. 7 is a read operation timing chart in the high performance mode.

FIG. 8 is a read operation timing chart in the high reliability mode and in the low cost mode.

FIG. 9 is a data copy operation timing chart in the high reliability mode.

### DESCRIPTION OF THE EMBODIMENT

An embodiment of the present invention will be described in detail using the drawings below.

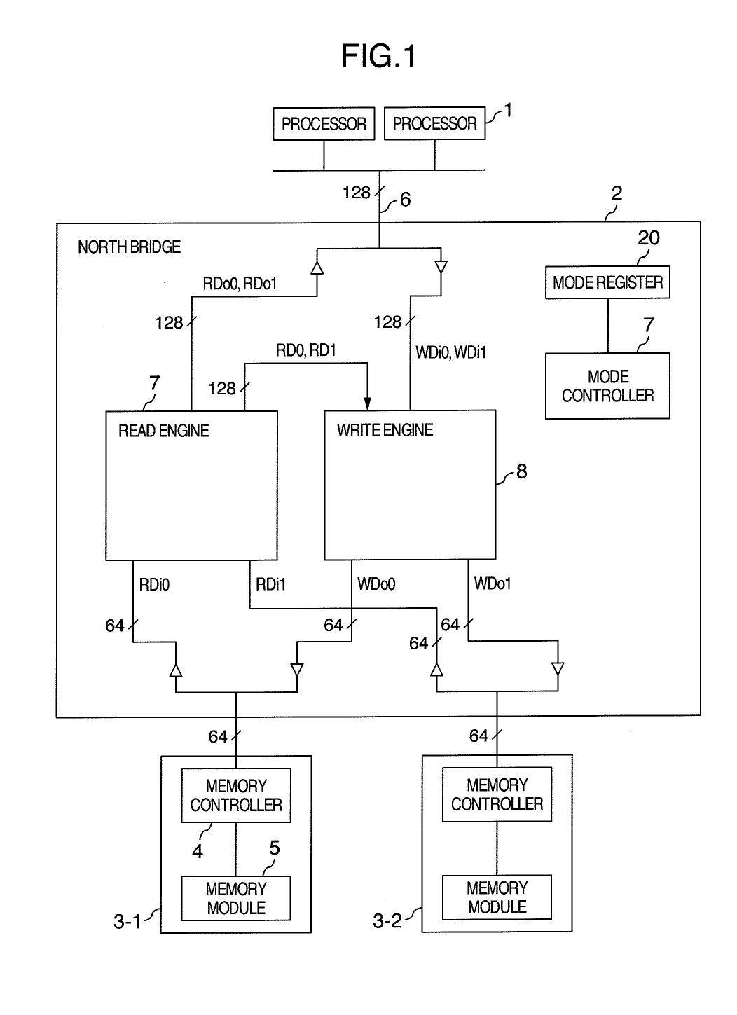

FIG. 1 shows an embodiment of the present invention. FIG. 1 shows a configuration diagram of a processor 1, a north bridge (a system controller) 2, and a storage device 3 in an information processing apparatus. On storage devices 3-1, 3-2 a memory controller 4 and a memory module 5 are mounted. The storage device 3 is configured in a form of a memory card, etc. The processor 1 and the north bridge 2 transfer data in a 128 bits width via a bus between processor and north bridge 6.

The north bridge 2 divides the 128 bits data from the processor 1 into two and transfers the divided two 64 bits data to the storage devices 3-1, 3-2 distributing or time dividing them according to the operation mode.

The north bridge 2 includes a read engine 7, a write engine 8, a mode controller 9, and a mode register 20.

The mode controller 9 realizes four operation modes of a high performance mode, a low cost mode, a high reliability mode, and a data copy mode controlling the read engine 7 and the write engine 8. In a system in which a high performance is required it realizes the high performance mode and it can improve the throughput by using the storage devices 3-1, 3-2 simultaneously and in parallel. In a system in which the low cost is required it realizes the low cost mode and it can realize a low cost system by making the system operate with only the storage device 3-1 or only 3-2. In a system in which the high reliability is required it realizes the high reliability mode and it can improve the availability by using the storage devices 3-1, 3-2 in duality. Also, it can realize the hot-swap of the storage devices by temporarily transferring from the high reliability mode to the low cost mode. At the hot-addition it realizes the data copy mode and copies data on the other storage device to an added storage device.

To the mode register 20 the operation mode designated from the system (the user) is set and it gives an operation instruction to the mode controller 9.

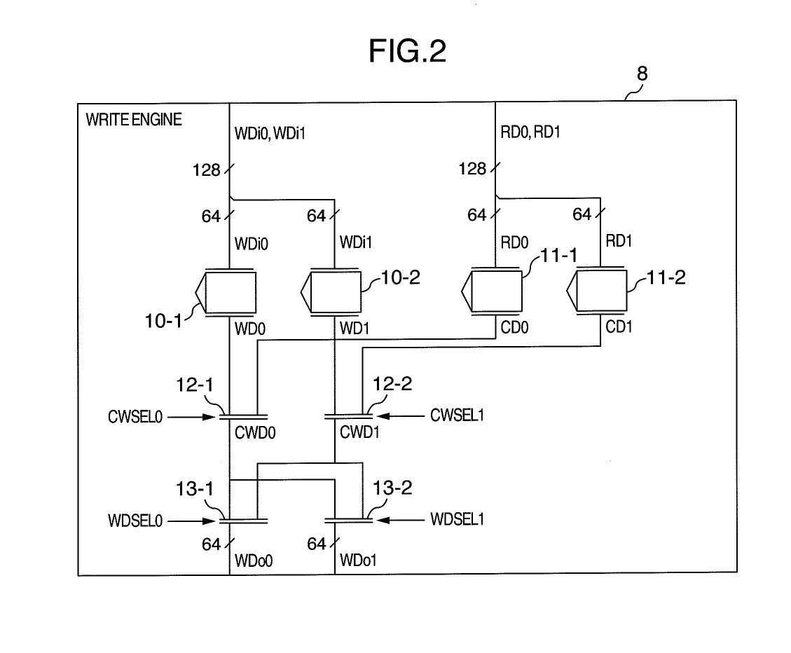

FIG. 2 shows a configuration diagram of the write engine 8 on the north bridge 2. The write engine 8 includes write data buffers 10-1, 10-2, copy data buffers 11-1, 11-2, selectors between write data and copy data 12-1, 12-2, and write data mode selectors 13-1, 13-2.

The 128 bits data transferred from the processor 1 is divided into two 64 bits write data WDi0, WDi1 and stored in the write data buffers 10-1, 10-2. The two 64 bits read data RD0, RD1 transferred from the read engine 7 are stored in the copy data buffers CD0, CD1.

Data WD0 read out from the write data buffer 10-1 and data CD0 read out from the copy data buffer 11-1 are transferred to the selector between write data and copy data 12-1 and data WD1 read out from the write data buffer 10-2 and data CD1 read out from the copy data buffer 11-2 are transferred to the selector between write data and copy data 12-2. The selectors between write data and copy data 12-1, 12-2 are controlled by select signals CWSEL0, CWSEL1 from the mode controller 9.

Data CWD0, CWD1 output from the selectors between write data and copy data 12-1, 12-2 are transferred to the write data mode selectors 13-1, 13-2 respectively. The write data mode selectors 13-1, 13-2 are controlled by select signals WDSEL0, WDSEL1 from the mode controller 9. 64 bits data WDo0, WDo1 output from the write data mode selectors 13-1, 13-2 are transferred to the storage devices 3-1, 3-2.

The write data buffers 10-1, 10-2 are configured with 2 ports RAM and performs the write of data controlling a write address WDBF_WA and a write enable WDBF_WE (not shown) and performs the read of data controlling a read address WDBF_RA (not shown).

The copy data buffers 11-1, 11-2 are also configured with 2 ports RAM and performs the write of data controlling a copy data buffer write address CDBF_WA and a copy data buffer write enable CDBF_WE (not shown) and performs the read of data controlling a copy data buffer read address CDBF_RA (not shown).

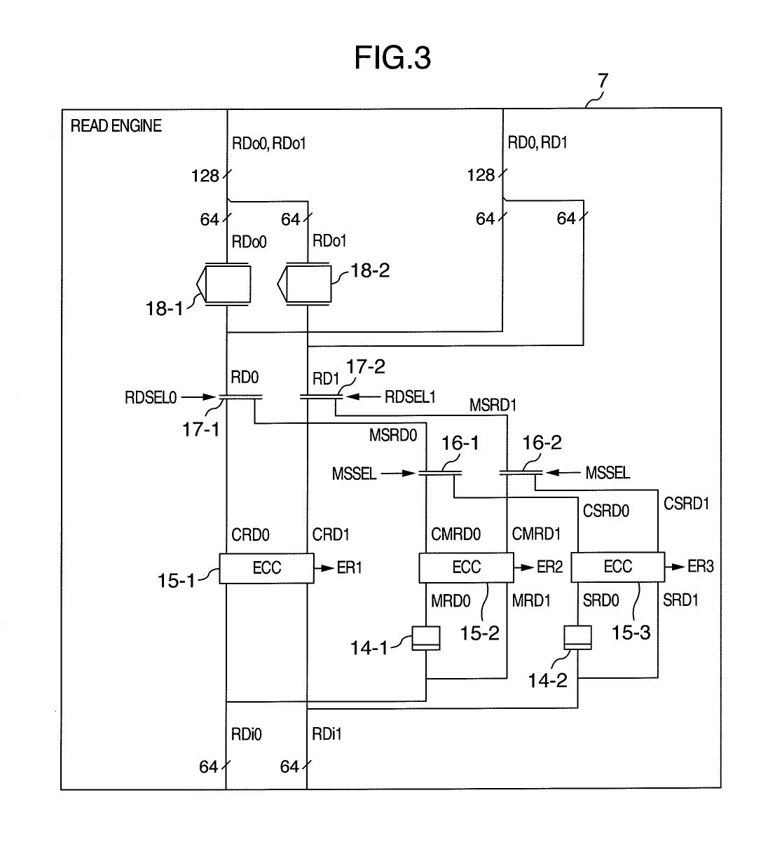

FIG. 3 shows a configuration diagram of the read engine 7 on the north bridge 2. The read engine 7 includes flip-flops 14-1, 14-2, ECC circuits 15-1, 15-2, 15-3, selectors between master data and slave data 16-1, 16-2, read data mode selectors 17-1, 17-2, and read data buffers 18-1, 18-2.

64 bits data RDi0, RDi1 transferred from the storage devices 3-1, 3-2 are transferred to the ECC circuit 15-1 and correction data CRD0, CRD1 are transferred to the read data mode selectors 17-1, 17-2. If an error which cannot be corrected at the ECC circuit 15-1 is detected, an error signal ER1 is sent out to the mode controller 9.

The 64 bits data RDi0 transferred from the storage device 3-1 is transferred to the flip-flop 14-1 and transferred to the ECC circuit 15-2 as data MRD0 which is data delayed by 1 cycle and at the same time it is transferred to the ECC circuit 15-2 as data MRD1 as it is, and correction data CMRD0, CMRD1 are transferred to the selectors between master data and slave data 16-1, 16-2. If an error which cannot be corrected at the ECC circuit 15-2 is detected, an error signal ER2 is sent out to the mode controller 9.

Similarly, the 64 bits data RDi1 transferred from the storage device 3-2 is transferred to the flip-flop 14-2 and transferred to the ECC circuit 15-3 as data SRD0 which is data delayed by 1 cycle and at the same time it is transferred to the ECC circuit 15-3 as data SRD1 as it is, and correction data CSRD0, CSRD1 are transferred to the selectors between master data and slave data 16-1, 16-2. If an error which cannot be corrected at the ECC circuit 15-3 is detected, an error signal ER3 is sent out to the mode controller 9.

The selectors between master data and slave data 16-1, 16-2 are controlled by a select signal MSSEL from the mode controller 9. Data MSRD0, MSRD1 output from the selectors between master data and slave data 16-1, 16-2 are transferred to the read mode selectors 17-1, 17-2 respectively.

The read data mode selectors 17-1, 17-2 are controlled by select signals RDSEL0, RDSEL1 from the mode controller 9. 64 bits data RD0, RD1 output from the read data mode selectors 17-1, 17-2 are transferred to the read data buffers 18-1, 18-2 and the copy data buffers 11-1, 11-2.

The read data buffers 18-1, 18-2 are configured with 2 ports RAM and performs the write of data controlling a read data buffer write address RDBF_WA and a read data buffer write enable RDBF_WE (not shown) and performs the read of data controlling a read data buffer read address RDBF_RA (not shown.

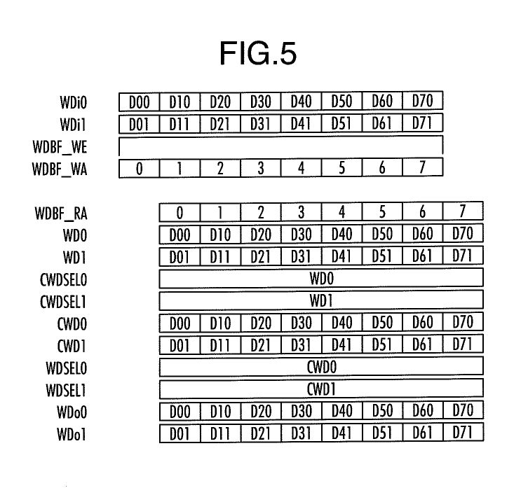

FIG. 5 is a timing chart showing an operation of the north bridge 2 (the write engine 8) when transferring data from the processor 1 to the storage device 3 in the high performance mode.

Data D00-D71 transferred from the processor 1 enter in the write engine 8 of FIG. 2 and are stored in the write data buffers 10-1, 10-2 by controlling the write data buffer write enable WDBF_WE and the write data buffer write address WDBF_WA as shown in FIG. 5.

The write data buffer read address WDBF_RA is incremented every cycle and the data WD0, WD1 are read out, the data WD0, WD1 are selected respectively by the select signals CWDSEL0, CWDSEL1 of the selectors between write data and copy data 12-1, 12-2 and the data CWD0, CWD1 are output, the CWD0, CWD1 are selected respectively by the select signals WDSEL0, WDSEL1 of the write data mode selectors 13-1, 13-2 and data WDo0, WDo1 are output.

As a result, the transfer data WDo0 to the storage device 3-1 become D00, D10, . . . , D70 and the transfer data WDo1 to the storage device 3-2 become D01, D11, . . . , D71.

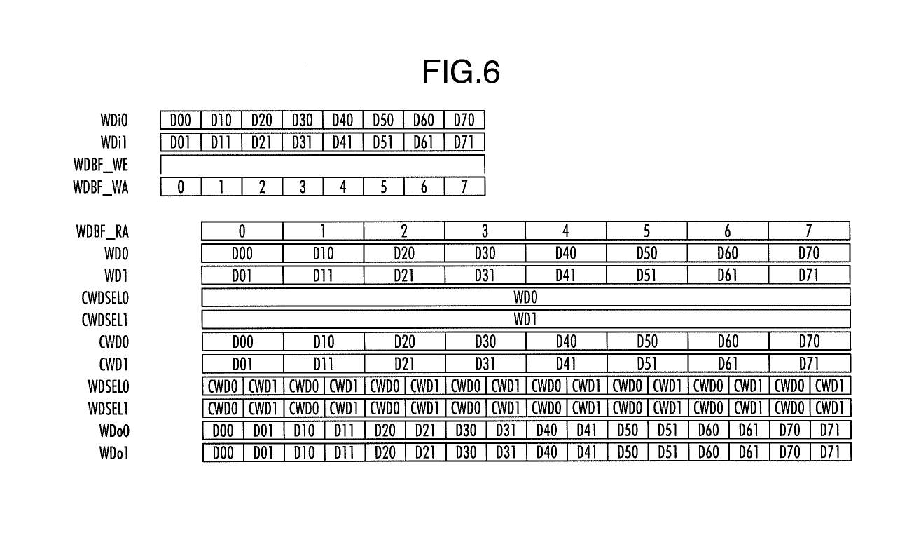

FIG. 6 is a timing chart showing an operation of the north bridge 2 when transferring data from the processor 1 to the storage device 3 in the high reliability mode and in the low cost mode.

The data D00-D71 transferred from the processor 1 enter in the write engine 8 of FIG. 2 and are stored in the write data buffers 10-1, 10-2 by controlling the write data buffer write enable WDBF_WE and the write data buffer write address WDBF_WA as shown in FIG. 6.

The read address WDBF_RA of the write data buffers 10-1, 10-2 is incremented every two cycles and the data WD0, WD1 are read out, the data WD0, WD1 are selected respectively by the select signals CWDSEL0, CWDSEL1 of the selectors between write data and copy data and the data CWD0, CWD1 are output, the data CWD0, CWD1 are alternatively selected every 1 cycle by the select signals WDSEL0, WDSEL1 of the write data mode selectors 13-1, 13-2 and the data WDo0, WDo1 are output.

As a result, the transfer data WDo0, WDo1 to the storage devices 3-1, 3-2 both become D00, D01, D10, D71.

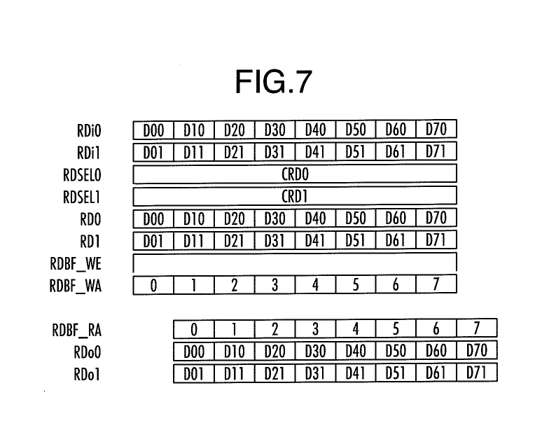

FIG. 7 is a timing chart showing an operation of the north bridge 2 (the read engine 7) when transferring data from the storage device 3 to the processor 1 in the high performance mode.

The data D00, D10, . . . , D70 transferred from the storage device 3-1 and the data D01, D11, . . . , D71 transferred from the storage device 3-2 enter in the read engine 7 in FIG. 3 and are error corrected at the ECC circuit 15-1 (CRD0, CRD1). When the error cannot be corrected the error signal ER1 is sent out to the mode controller 9. By making the select signals RDSEL0, RDSEL1 of the read data mode selectors 17-1, 17-2 to be CRD0, CRD1 respectively, data to be stored in the read data buffers 18-1, 18-2, the RD0 become D00, D10, D70 and RD1 become D01, D11, . . . , D71.

By controlling the read data buffer write enable RDBF_WE, the read data buffer write address RDBF_WA as shown in FIG. 7, the data RD0, RD1 are stored in the read data buffers 18-1, 18-2.

After the data are accommodated in the read data buffers 18-1, 18-2, the read data buffer read address RDBF RA is incremented every cycle and data RDo0, RDo1 are read out.

As a result, the transfer data RDo0 to the processor 1 become D00, D10, . . . , D70 and the transfer data RDo1 become D01, D11, . . . , D71.

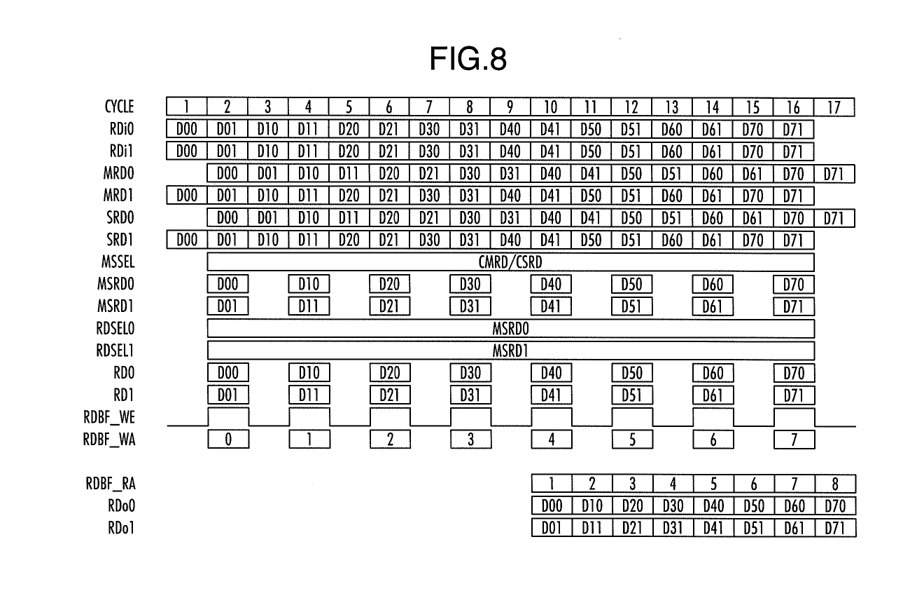

FIG. 8 is a timing chart showing an operation of the north bridge 2 when transferring data from the storage device 3 to the processor 1 in the high reliability mode and the low cost mode.

Data D00, D01, D10, . . . , D71 transferred from the storage device 3-1 and data D00, D01, D10, . . . , D71 transferred from the storage device 3-2 enter in the read engine 7 of FIG. 3.

Data which is 64 bits data RDi0 transferred from the storage device 3-1 delayed by 1 cycle at the flip-flop 14-1 is supposed to be MRD0, and data which is not delayed is supposed to be MRD1. Looking at the second, fourth, sixth, eighth, 10th, 12th, 14th, and 16th cycles of the MRD0, MRD1 respectively, the MRD0 which is the data delayed by 1 cycle become D00, D10, D70, and the MRD1 which is the data not delayed become D01, D11, . . . , D71. These data are error corrected at the ECC circuit 15-2 and become master data CMRD0, CMRD1. If the error cannot be corrected, the error signal ER2 is sent out to the mode controller 9.

Similarly, 64 bits data RDi1 transferred from the storage device 3-2 become slave data CSRD0, CSRD1 after being error corrected at the ECC circuit 15-3. If the error cannot be corrected, the error signal ER3 is sent out to the mode controller 9.

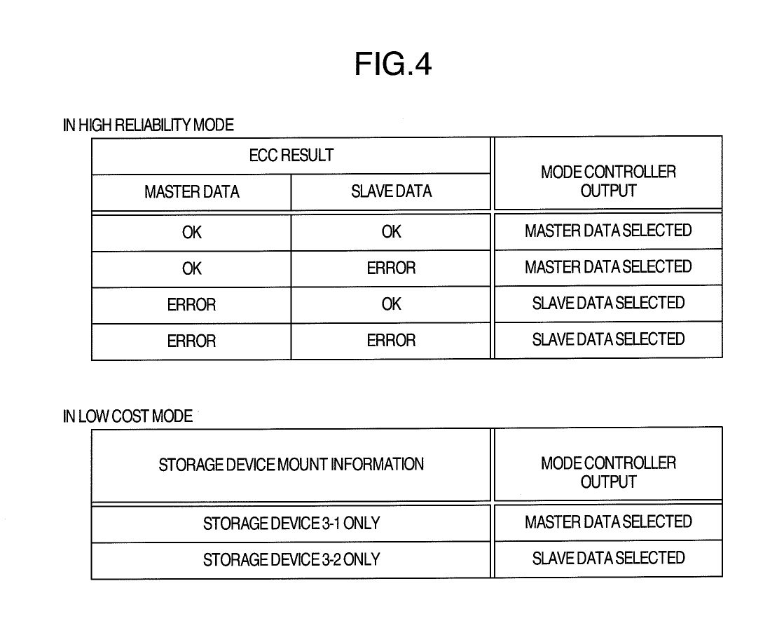

The select signal MSSEL of the selectors between master data and slave data 16-1, 16-2 selects the data shown in FIG. 4 (the operation chart of the mode controller 9) (MSRD0, MSRD1).

Namely, in the high reliability mode, according to the ECC result of each of the master data CMRD0, CMRD1 and the slave data CSRD0, CSRD1, if an error has occurred at either of the data, the data on the OK side is selected. If both of them are OK, either may be selected, but, for example, the master data is selected. If both are error, the output data has no meaning but it is assumed to select the slave data.

Also, in the low cost mode, according to the storage device mount information, when only the storage device 3-1 is mounted the master data CMRD0, CMRD1 are selected, when only the storage device 3-2 is mounted the slave data CSRD0, CSRD1 are selected. The storage device mount information may be given to the mode controller 9 detecting the mount condition of the storage devices by H/W or it may be given to the mode controller 9 setting it to the mode register 20 according to the instruction from the system (the user).

Next, by making the select signals RDSEL0, RDSEL1 of the read data mode selectors 17-1, 17-2 to be the MSRD0, MSRD1 respectively, the data RD0 to be stored in the read data buffer 18-1 become D00, D10, . . . , D70 and the data RD1 to be stored in the read data buffer 18-2 become D01, D11, . . . , D71.

By controlling the read data buffer write enable RDBF_WE and the read data buffer write address RDBF_WA as shown in FIG. 8, the data RD0, RD1 are stored in the read data buffers 18-1, 18-2.

After the data are accommodated in the read data buffers 18-1, 18-2, the read data buffer read address RDBF-RA is incremented every cycle from the tenth cycle and data RDo0, RDo1 are read out.

As a result, the transfer data RDo0 to the processor 1 become D00, D10, . . . , D70 and the transfer data RDo1 become D01, D11, . . . , D71.

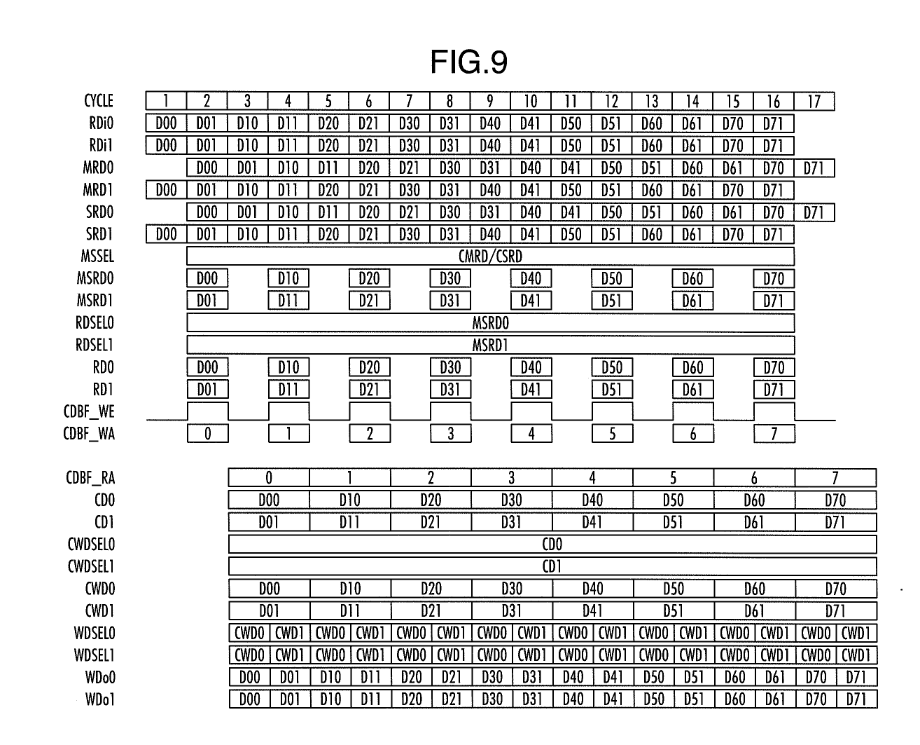

FIG. 9 is a timing chart showing a data copy operation which copies data from the storage device 3-1 to the storage device 3-2 in the high reliability mode.

Data D00, D01, D10, . . . , D71 transferred from the storage device 3-1 enter in the read engine 7 of FIG. 3.

Data which is data RDi0 transferred from the storage device 3-1 delayed by 1 cycle at the flip-flop 14-1 is supposed to be MRD0 and data which is not delayed is supposed to be MRD1. Looking at the second, fourth, sixth, eighth, 10th, 12th, 14th, and 16th cycles of the MRD0, MRD1 respectively, the MRD0 become D00, D10, . . . , D70 and the MRD1 become D01, D11, . . . , D71. These data are error corrected at the ECC circuit 15-2 and become master data CMRD0, CMRD1.

The select signal MSSEL of the selectors between master data and slave data 16-1, 16-2 selects the master data CMRD0, CMRD1 (MSRD0, MSRD1).

By making the select signals RDSEL0, RDSEL1 of the read data mode selectors 17-1, 17-2 to be the MSRD0, MSRD1 respectively, data to be stored in the copy data buffers 11-1, 11-2 which are in the write engine 8, RD0 become D00, D10, . . . , D70 and RD1 become D01, D11, . . . , D71.

The data RD0, RD1 to be stored in the copy data buffers 11-1, 11-2 are sent to the write engine 8, and by controlling the copy data buffer write enable CDBF_WE and the copy data buffer write address CDBF_WA as shown in FIG. 9, the data RD0, RD1 are stored in the copy data buffers 11-1, 11-2.

The copy data buffer read address CDBF_RA is incremented every two cycles and data CD0, CD1 are read out, the data CD0, CD1 are selected respectively by the select signals CWDSEL0, CWDSEL1 of the selectors between write data and copy data 12-1, 12-2 and data CWD0, CWD1 are output, the CWD0, CWD1 are alternatively selected every 1 cycle by the select signals WDSEL0, WDSEL1 of the write data mode selectors 13-1, 13-2 and data WDo0, WDo1 are output.

As a result, the transfer data WDo0, WDo1 to the storage devices 3-1, 3-2 both become D00, D01, D10, . . . , D71. Now, in this embodiment, as the memory controllers of the storage devices 3-1, 3-2 operate in synchronization the process to write back the data from the storage device 3-1 to the storage device 3-1 is also performed.

From the above, it is possible to realize an operation mode control method of a storage device corresponding to a high performance system, a high reliability system, and a low cost system in a single system according to an object.

It should be further understood by those skilled in the art that although the foregoing description has been made on embodiments of the invention, the invention is not limited thereto and various changes and modifications may be made without departing from the spirit of the invention and the scope of the appended claims.

1. An information processing apparatus comprising a processor, a plurality of storage devices, and a system controller which controls the plurality of storage devices, wherein the system controller comprises a unit which divides data of processor bus width from the processor into a plurality of divided data, a first transfer unit which simultaneously and in parallel transfers the plurality of divided data to the plurality of storage devices distributing them, a second transfer unit which sequentially transfers the plurality of divided data to the same storage device, and a mode control unit which operates either the first transfer unit or the second transfer unit.

2. An information processing apparatus of claim 1, wherein the system controller comprises a third transfer unit which combines the plurality of divided data read out simultaneously at a time from the plurality of storage devices into data of processor bus width and transfers it to the processor, and a fourth transfer unit which combines the plurality of divided data sequentially read out separately in a plurality of times from one storage device into data of processor bus width and transfers it to the processor, and the mode control unit operates the third transfer unit when it operates the first transfer unit and operates the fourth transfer unit when it operates the second transfer unit.

3. An information processing apparatus of claim 2, wherein the fourth transfer unit comprises a unit which selects any one of the divided data sequentially read out from each storage device, and the mode control unit, when an error has occurred in the divided data read out from the storage device in operation, operates the fourth transfer unit switching to the divided data read out from the other storage device.

4. An information processing apparatus of claim 2, wherein the fourth transfer unit comprises a unit which selects any one of the data sequentially read out from each storage device, and the mode control unit, when only one storage device is mounted, selects the data read out from said storage device and operates the fourth transfer unit.

5. An information processing apparatus of claim 2, wherein the system controller comprises a storage unit which temporarily stores the divided data read out from the first storage device to copy the divided data of the first storage device to the second storage device, the fourth transfer unit comprises a unit which transfers the combined data to the storage unit, the second transfer unit comprises a select unit which selects the combined data stored in the storage unit as transfer data, and the mode control unit operates the fourth transfer unit so that the divided data read out from the first storage device is transferred to the storage unit and operates the second transfer unit so that the combined data stored in the storage unit is transferred to the second storage device when a data copy operation is performed.

6. An information processing apparatus of claim 5, wherein the mode control unit, when an error has occurred in the divided data read out from the storage device in operation, makes the data copy operation to be performed after the storage device in which the error has occurred has been exchanged.

7. An information processing apparatus of claim 1, wherein the storage device comprises a memory controller and a memory module.

8. An information processing apparatus comprising a processor, a plurality of storage devices, and a system controller which controls the plurality of storage devices, wherein the system controller comprises a plurality of write data buffers which divide data of processor bus width from the processor into a plurality of divided data and store them, a plurality of first selectors corresponding to each storage device which selects divided data to transfer to each storage device from the divided data read out from the plurality of write data buffers, a mode register which designates an operation mode of said information processing apparatus, and a mode control part which controls an access to the plurality of storage devices according to an instruction of the mode register,
the mode control part, when a high performance mode is designated, reads out simultaneously the plurality of divided data from the plurality of write data buffers, makes the first selectors select the plurality of divided data simultaneously read out, and simultaneously transfers selected plurality of divided data to corresponding plurality of storage devices, and when a high reliability mode is designated, sequentially reads out the divided data from the plurality of write data buffers, makes the first selectors sequentially select the divided data sequentially read out, and sequentially transfers selected divided data to each storage device.

9. An information processing apparatus of claim 8, wherein the system controller comprises a first check circuit which performs an error detection and correction of the plurality of divided data simultaneously transferred from the plurality of storage devices, a first register which temporarily retains the divided data transferred from one storage device, a second check circuit which combines the divided data retained in the first register and the divided data transferred next into data of processor bus width and performs an error detection and correction, a second register which temporarily retains the divided data transferred from the other storage device, a third check circuit which combines the divided data retained in the second register and the divided data transferred next into data of processor bus width and performs an error detection and correction, a second selector which selects either a correction output of the second check circuit or a correction output of the third check circuit, a third selector which selects either a correction output of the first check circuit or an output of the second selector, and a read data buffer which stores an output of the third selector and sends it to the processor,
the mode control part, when the high performance mode is designated, makes the third selector select the correction output of the first check circuit, and when the high reliability mode is designated, makes the third selector select the output of the second selector.

10. An information processing apparatus of claim 9, wherein the system controller comprises a plurality of copy data buffers which store the output of the third selector and a fourth selector which selects either the output of the plurality of write data buffers or the output of the plurality of copy data buffers and sends it to the first selector,
the mode control part, when a data copy mode is designated, makes the third selector select the output of the second selector, makes the fourth selector select the output of the plurality of copy data buffers, sequentially reads out the divided data from the plurality of copy data buffers, makes the first selector sequentially select the divided data sequentially read out, and sequentially transfers selected divided data to each storage device.
